(19) United States
(12) Patent Application Publication
(10) Pub. No.: US 2004/0070688 A1
(43) Pub. Date: Apr. 15, 2004

(54) Method of video transmission over a synchronous transmission technology network

(76) Inventors: Alexander Bazarsky, Jerusalem (IL); Yacov Bortman, Bat-Yam (IL); Avner Libman, Holon (IL)

Correspondence Address: BROWDY AND NEIMARK, P.L.L.C., 624 NINTH STREET, NW, SUITE 300, WASHINGTON, DC, 20001-5303, US

(21) Appl. No.: 10/468,821

(22) PCT Filed: Feb. 14, 2002
(86) PCT No.: PCT/IL02/00113

(30) Foreign Application Priority Data
Feb. 25, 2001 (IL) 141632

(51) Int. Cl. H04N 7/04

(52) U.S. Cl. 348/469

(57) ABSTRACT

The application describes a technique of synchronizing a digital video signal for transmitting it in the uncompressed form via a synchronous hierarchy network having its internal clock, by standard frames of the network. The technique comprises steps of obtaining the video signal as a Serial Digital Interface (SDI) signal having its initial video clock and presenting a succession of video frames, storing said video signal, using the video clock, in a buffer memory having capacity of one or more complete video frames, reading said video signal from the buffer memory using a transport clock derived from the internal clock of the synchronous hierarchy network.

### FIELD OF THE INVENTION

The invention is in the field of transmission of video signals over a synchronous transmission technology network, and equipment therefor.

### BACKGROUND OF THE INVENTION

At early stages of the video transmission technology, video signals were obtained, transmitted and received in the analogous form. Modern technologies of video transmission become more and more adapted to digital processing, so a lot of efforts have been applied to provide suitable transmitting, storage and synchronizing equipment.

It is understood, that for transmitting video signals by means of any digital technology, they should be properly synchronized for being received with adequate frequency and quality at a TV receiving side.

JP 6098196-A proposes a simple method of reproducing, at a receiving side, the same television frame frequency as at a transmitting side, by extraction a transmission path clock (for example, clock of an SDH network). The SDH clock is used for producing a so-called black-burst signal to synchronize the originally analog video signal. More particularly, the source of analog video signal is synchronized and then the signal is converted into a digital form to be coded and transmitted via the SDH network. In that solution, the SDH clock serves just a synchronizing signal used for transmitting a video signal in a closed system. On the receiving side, a video monitor is synchronized with the same black burst signal restored from the SDH clock.

At present, most video cameras and all the professional ones produce video output in the digital form, for example as Serial Digital Interface (SDI) signals. SDI video signals are delivered as a bit serial stream at various bit rates including inter alia 270 Mbps SDI signals, 360 Mbps SDI signals and 1.5 Gbps SDI signals.

At the present stage, problems of proper transmission of video signals via modem transport networks are on the agenda. One of the main problems is preserving stability of a video signal incoming a transport network up to the moment it leaves the transport network to be processed at a receiving side.

Modem synchronous hierarchy transmission technologies such as SDH (Synchronous Digital Hierarchy—a European standard) and SONET (Synchronous Optical NETwork—a North-American standard) propose broadband services allowing uncompressed and multi-channel video transmission and advantageous quality monitoring. Moreover, SDH and SONET are adapted to synchronize incoming signals having clock different from the internal SDH/SONET clock by inserting stuffing bytes into a standard SDH/SONET frame. Quantity of such stuffing bytes changes from frame to frame, and in the case of transmitting video leads to appearance of a “wander effect” in the outgoing signal. To remove this effect, quite complex equipment is required, which might introduce its own distortions into the signal.

### OBJECT OF THE INVENTION

It is therefore an object of the invention to propose a method and a system for synchronizing an uncompressed digital video signal to be transmitted via a transport network such as SONET or SDH, which would resolve the problems outlined above.

### SUMMARY OF THE INVENTION

It has been realized by the Inventor that the above-described synchronizing means developed in the known synchronous hierarchy technologies for transmitting data are not adapted for cases when the data is a digitized video signal. On the other hand, stability of the internal clock of SONET or SDH networks is sufficiently high to ensure the required stability of the outgoing video signal and. There is thus a problem of two different clocks existing in two digital systems, while the systems should produce a resulting outgoing signal satisfying the requirements imposed upon video signals.

The purpose of the invention could be thus achieved by resolving the above problem.

According to a first aspect of the invention, there is proposed a method of synchronizing a digital video signal for transmitting it in the uncompressed form via a synchronous hierarchy network having its internal clock, by standard frames of said network, the method comprising steps of:

obtaining the video signal as a Serial Digital Interface (SDI) signal having its initial video clock and representing succession of video frames,

storing said video signal, using the video clock, in a buffer memory having capacity of one or more complete video frames,

reading said video signal from the buffer memory, preferably by bytes, using a so-called transport clock derived from the internal clock of said network.

The synchronous transmission technologies, which are known today, are optical network synchronous hierarchies SONET and SDH, and the concept of the present invention is readily applicable to these two cases.

Preferably, the buffer memory has capacity of a single complete video frame.

It has been realized by the Inventor that, such a method of synchronizing enables eliminating the wander effect by utilizing one intrinsic feature of any video transmission which has never been used before for transmitting video via synchronous hierarchy networks. This feature resides in the fact that repetition of one video frame twice, or dropping one video frame during a particular time period is non-perceivable by a human eye. Such a time period is calculated for various TV standards having specific respective requirements to stability of transmission. Therefore, even if frequencies of the video and transport clock are not ideally suitable to one another for some reasons and, for example, a situation is created when a read clock comes while a new video frame is not yet stored in the buffer, it will not be harmful for the quality of transmission. In such a situation, the previous video frame will be read from the buffer memory for the second time without creating problems at a receiving end. The reason, for example, may reside in deviation of at least one of the clocks from its standard (the video and/or the SONET/SDH clock). Without the complete frame buffer memory such a situation would cause noticeable distortions in the received video picture.

The reading from the buffer memory may be accomplished in various ways (by bits, by bytes, by two bytes, in a number of steps using additional buffers, etc.). However, since the digitized video signal should be finally mapped by bytes into the standard frames of the synchronous network, the reading is preferably performed by bytes.

The transport clock is selected based on the bit rate of a data stream of. said network, suitable for transmitting the digitized video signal of a particular bit rate. For example, for transmitting one SDI channel of 270 Mbps via an SDH network, two STM-1 components of the STM-4 data stream are required.

It stems from the fact that a digital video signal transmitted as an 270 mbps SDI signal cannot be mapped into one basic SDH data stream STM-1 having the bit rate 155.52 Mbps, so theoretically, two STM-1 data streams would be necessary to carry this SDI signal. It is known, however, that in the SDH hierarchy there is no data stream comprising two STM-1 signals; the second level hierarchical data stream is STM-4 comprising four STM-1 signals and having the bit rate of 622.08 Mbps which will be considered the SDH internal clock for this case. One preferred example of the transport clock selection will be presented in the detailed description.

The Inventors have further realized that, the synchronizing of the digitized video signal according to the proposed method causes appearance of a periodically repeating mapping/stuffing pattern of the digitized video signal in the standard frames.

Indeed, when continuously inserting a particular integer number B of video bytes comprised in an integer number V of video frames into payloads of a succession of the synchronous hierarchy network frames such as SDH frames, the repeating mapping pattern should appear automatically, though it may have quite a long and hardly determinable period. However, at the receiving side where the video signal is recovered from the synchronous hierarchy frames, such a periodic pattern would be unknown and therefore not used. It should be noted, that for separating the video information from stuffing in SDH/SONET frames additional synchronizing bytes are usually inserted to indicate the beginning and the end of the informational bytes in the SDH/SONET bytes flow.

To simplify the recovering of the video information at the receiving side, the Inventors further proposed to fulfil the above-described method with a step of mapping the digitized video signal into said standard frames using a pre-selected periodically repeating pattern known at both the transmitting and the receiving side. In particular, it can be implemented by indicating a mapping pattern data used in each specific standard frame by means of a predetermined byte of said standard frame.

Such a predetermined byte can be called a video header byte. The video header byte may comprise data on the exact area in the payload occupied by the video bytes, for example by indicating the video standard used, a type of mapping of this specific frame, the current number of the video frame and the like.

In the frame of the present description, the term “pre-selected periodically repeating pattern” should be understood as a pre-selected order of inserting a particular integer number B of video bytes into payloads of an integer number S of the synchronous hierarchy standard frames, where B video bytes represent information comprised in an integer number V of video frames.

In other words, the pre-selected periodically repeating pattern is performed for mapping an integer number V of video frames into an integer number S of said network frames, provided by integer number B of bytes.

The number and location of video bytes and stuffing bytes in each particular frame among said S frames can be selected arbitrary, though it repeats itself each cycle comprising N of the standard frames, being equal to k*S frames, where k is either a positive integer number or a value inverse to a positive integer number.

The above will become apparent from examples of the pre-selected periodical mapping pattern presented in the detailed description. The examples will refer to two widely used video transmitting systems (the European PAL and the North-American NTSC).

More particularly, the method may include arbitrary selecting a mapping pattern type for each particular frame among the S frames, the mapping pattern type being a number and location of video bytes and stuffing bytes in said particular frame, and repeating the arbitrary selected mapping pattern types each cycle comprising N of the standard frames.

According to one specific version of the method, the pre-selected periodical mapping pattern is formed in N said standard successive frames by a limited number of the mapping pattern types, each frame from said N standard successive frames being assigned to a particular mapping pattern type.

The above-described method is advantageous for synchronizing a multi-channel video transmission. The method will then comprise steps of:

obtaining at least one additional video signal in the digital form, each having its video clock,

storing each of said additional video signals, using its corresponding video clock, in a buffer memory having a capacity of one or more complete video frames and associated with this particular additional video signal;

reading each of said additional video signals from its associated buffer memory, using said transport clock derived from the internal clock of said network,

thereby synchronizing different video signals initially having their corresponding video clocks by one and the same transport clock.

Preferably, the above method also comprises the mapping of each of said additional video signals using its corresponding predetermined periodic mapping pattern. The video signals may therefore be obtained according to different standards (PAL, NTSC, etc) and transmitted with different bit rates.

According to one particular and preferred embodiment of the present invention, there is proposed the above-described method for synchronizing and mapping two SDI digital video signals having the bit rate of 270 Mbps into one STM-4 data stream having the bit rate of 622.08 Mbps.

Owing to the proposed synchronizing and mapping of the digital video signals into the SONET/SDH standard frames, all the video channels are uniformly synchronized and can therefore be easily multiplexed-demultiplexed within the SONET/SDH network and, further, be processed at the receiving side without excessive equipment.

Based on the above-described method, the synchronizing is provided at each video channel of a multi-channel system. All video signals, upon passing their corresponding synchronizer acquire equal bit rates and can then be multiplexed say, for transmitting in a higher order data stream (such as STM-16 or STM-64).

According to another aspect of the invention, there is also provided a system for synchronizing an SDI (Serial Digital Interface) video signal having its video clock for transmitting thereof via a synchronous technology network having its internal clock, by standard frames of said network; the system comprising:

a buffer memory capable of storing in it video information comprised in one or more complete frames of the SDI video signal,

a write address generator for storing the video information in the buffer memory using said video clock,

a read address generator for reading the video information from the buffer memory using a transport clock derived from the internal clock of the synchronous technology network.

In an analogous manner, the synchronous transmission technology should be presently understood as the SONET or SDH synchronous hierarchy.

Preferably, the buffer memory has the capacity of a single video frame, in this case dropping or adding of one complete video frame would be minimally perceivable for the human eye. Also, the read address generator is preferably designed for reading the video information by bytes from the buffer memory.

According to the preferred embodiment of the synchronizing system, said read address generator further serves as a mapper for mapping the video information into said standard frames of the network by using a pre-selected periodic mapping pattern information preliminarily introduced in said read address generator. It goes without saying, that the same pre-selected pattern should be known at a receiving side for de-mapping.

Further, the read address generator serving as the mapper can be designed for indicating a mapping pattern data used in each specific standard frame by means of a predetermined byte of said standard frame.

According to the preferred embodiment of the invention, the read address generator comprises a counter of frames of said SDI video signal, a counter of the synchronous technology frames and bytes therein, a control unit capable of processing data obtained from said two frame counters and data on the pre-selected periodic mapping pattern to issue read request signals, said generator further comprises a read address counter synchronized by the transport clock and capable of processing said read request signals for producing a read address to be used for the reading from the buffer memory according to said pre-selected periodic mapping pattern.

According to a preferred embodiment of the system, it comprises a plurality of buffer memories, each associated with its write address generator and its read address generator, and each being adapted for buffering a particular SDI video signal belonging to a corresponding video channel.

In a further embodiment, said system with the plurality of the buffer memories is adapted for a respective plurality of SDI video signals having their particular bit rates, the system being capable of synchronizing and mapping. said video signals into respective SDH/SONET data streams, and is further provided with a multiplexer for multiplexing the. plurality of said data streams into one or more higher order SDH/SONET data streams.

Further aspects of the invention will become apparent as the description proceeds.

### BRIEF DESCRIPTION OF THE DRAWINGS

In order to understand the invention and to see how it can be carried out in practice, preferred embodiments will now be described, by way of non-limiting examples only, with reference to the accompanying drawings in which the same parts are likewise numbered, and in which:

FIG. 1 is a block-diagram schematically illustrating the inventive method and system of the present invention.

FIG. 2 is a block diagram of one embodiment of the read address generator shown in FIG. 1.

FIG. 3a illustrates a standard STM-4 frame of the SDH synchronous hierarchy technology (prior art).

FIG. 3b schematically illustrates an example of a pre-selected periodic mapping pattern which is proposed for transmitting a digitized 270 Mbps PAL video signal via SDH, according to the invention.

FIG. 3c schematically illustrates an example of a pre-selected periodic mapping pattern which can be used for transmitting via SDH a digitized 270 Mbps NTSC video signal according to the invention.

### DETAILED DESCRIPTION OF THE PREFERRED EMBODIMENTS

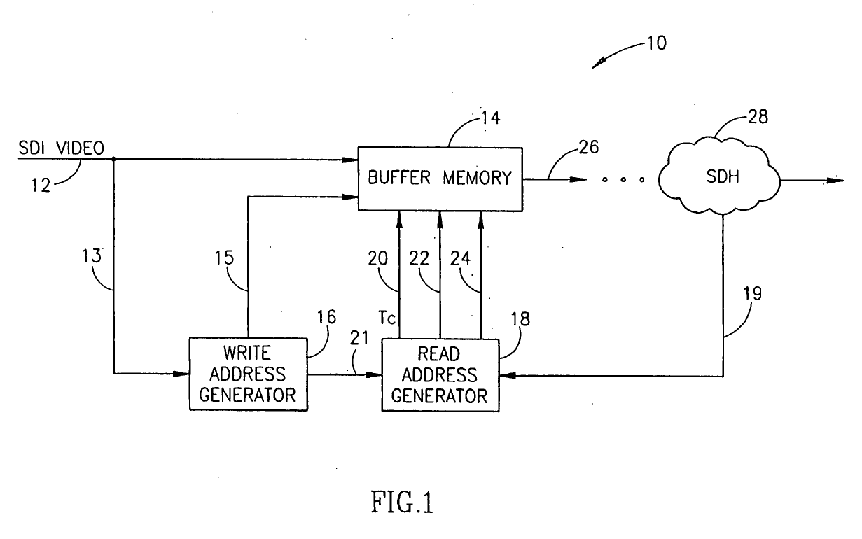

FIG. 1 schematically illustrates a system 10 implementing the method of video synchronization and transmission according to the invention. The system 10 actually presents a transmitting portion of a complete combined system which includes, at a receiving end thereof, a structure (not shown in this figure) analogous but inverse to system 10. According to the concept, at least one SDI video signal (marked 12) is applied to a Buffer Memory 14 to be stored therein according to a signal produced by a Write Address Generator (WAG) 16 which works in synchronism with the clock. of the SDI video signal 12 (so-called initial video clock 13). The WAG 16 produces a continuous succession of addresses 15 for recording the digitized video signal, from the beginning of a video frame, into the block 14. It should be noted that the beginning of the video frame is always allocated in the same predetermined address of the Buffer Memory. The Buffer Memory presents an asynchronous dual port memory and preferably has a capacity of one video digitized frame.. The video frames are read from the Buffer Memory according to another clock (so-called transport clock schematically marked 20) derived from the internal clock 19 of the synchronous transmission technology network (in this figure, SDH), which is applied to A Read Address Generator 18. In one particular example, the SDI video signal has the bit rate of 270 Mbps and thus can be mapped into two STM-1 components of an SDH data stream STM-4 . For this example, the transport clock Tc can be calculated as follows:

Tc=622.08 Mbps/2*8=38.88 Mbps, where

622 Mbps -is the internal clock of SDH data stream STM-4,

2—indicates a half of the STM-4 data stream into which the video signal is mapped,

8—indicates 8 bits in one byte, since mapping is performed by bytes.

However, another Tc can be used, which is obtained by dividing the internal SDH clock by a divisor being a multiple of 8. The transport clock for other standard rates of the SDI video signals can be selected in an analogous s manner.

In addition to the synchronizing function, the Read Address Generator 18 has a function of a mapper, since it receives information 21 on a video frame start and produces not only the transport clock 20, but also:

signals of read request 22 according to a selected order of the mapping pattern in each particular SDH frame to which the video information is mapped, and

read address signal 24 which calculates the address for reading data from the buffer memory according to a particular result of the previous read request (e.g., if there was no read request in a previous moment of time stated by the transport clock, the read address remains the same as at the previous moment, and if there was such a request-the read address should be increased by one).

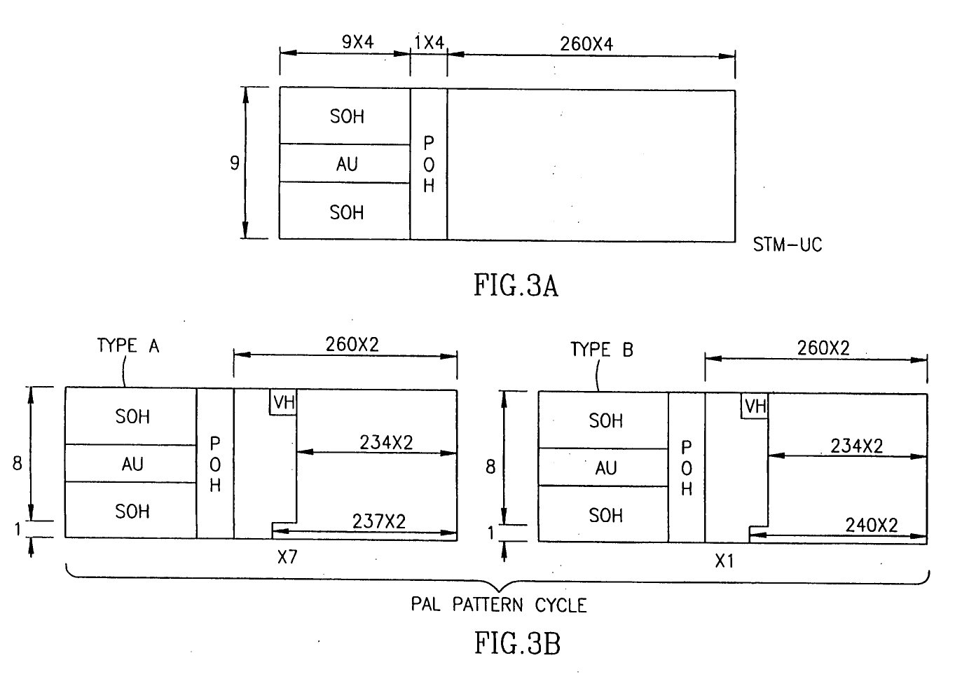

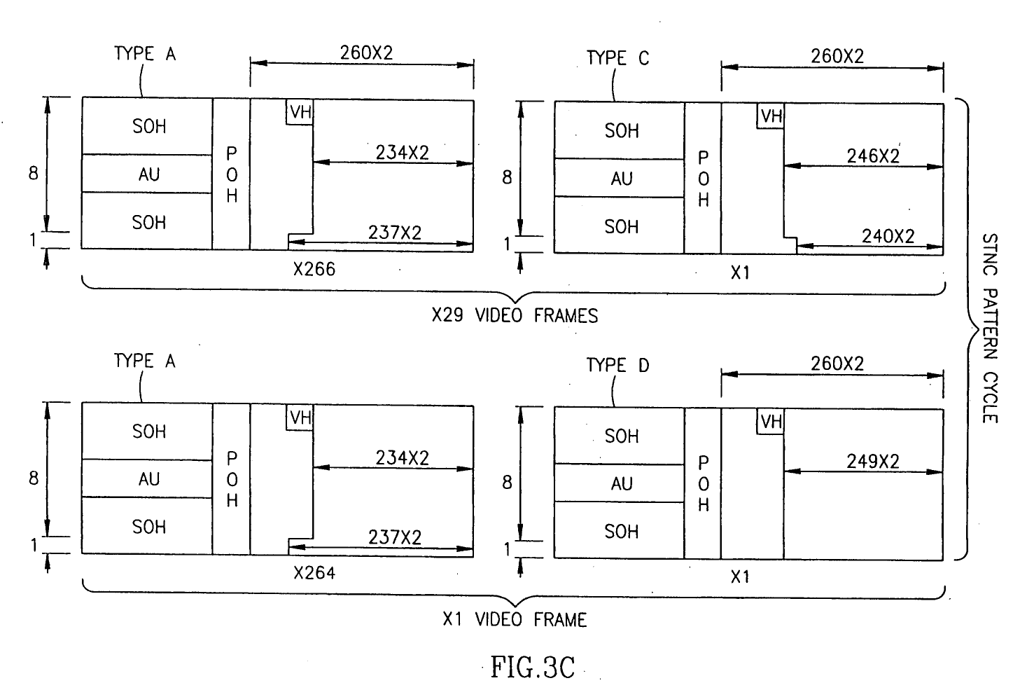

Consequently, the video signal 26 which is finally read from the buffer memory 14, is synchronized with the SDH internal clock 19 and ready for being mapped, in a predetermined manner, into a selected transport data stream of an SDH network 28. The mapping pattern per se will be explained with reference to FIGS. 3a, 3b, 3c.

The receiving portion (not shown) of the complete system will perform the inverse transformation of the SDH signal. As mentioned above, the receiving portion will comprise the elements analogous to those of the transmitting portion (i.e., the WAG, RAG and a buffer memory). However, the WAG of the receiving portion will work with the same clock and rules as the RAG of the transmitting portion, while the RAG of the receiving portion operates using the video clock formed from the transport clock ,and using the rules of the WAG of the transmitting portion.

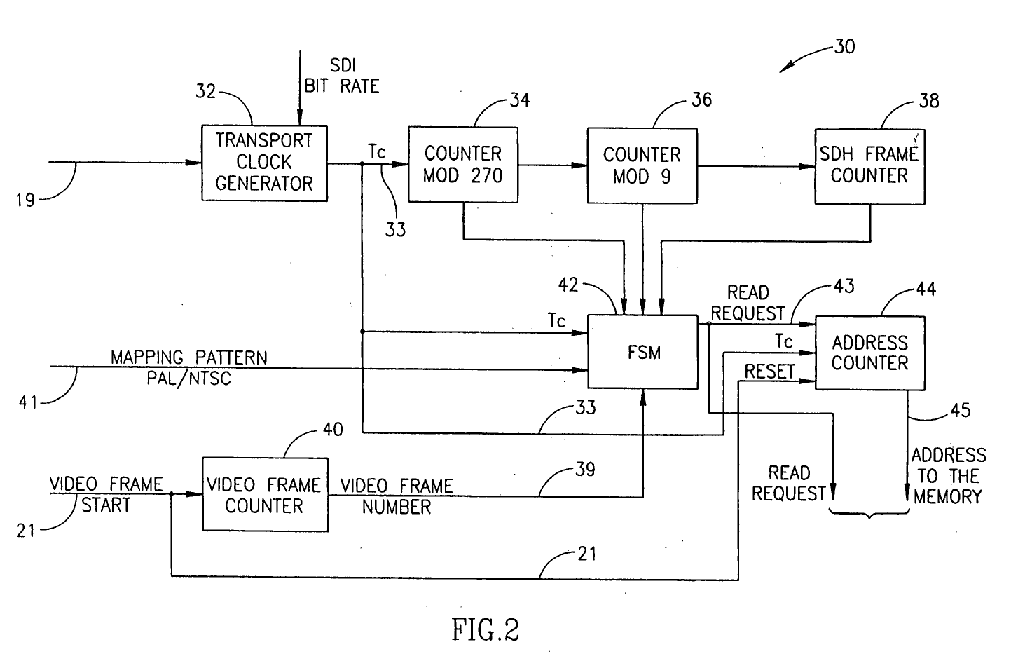

FIG. 2 is a schematic block-diagram describing, in more detail, one embodiment 30 of the Read Address Generator units shown FIG. 1. The unit 30 performs the following functions using the following blocks:

block 32 for generating the transport clock (Tc) 33 based on the SDH internal clock;

blocks 34, 36 and 38 responsible for counting columns of an SDH frame (counter modulus 270), rows of an SDH frame (counter modulus 9) and complete SDH frames (SDH frame counter) according to the transport clock, thereby preparing data for mapping the video information in the SDH standard frames;

block 40 for counting video frames based on signals 21 of the video frame beginning, also for preparing data 39 for mapping the video information;

Final State Machine block 42, which, being synchronized by the transport clock Tc, receives data from the blocks 34, 36, 38 and 40, and instructions on the selected periodic mapping pattern 41 which depends on the video transmitting system (PAL, NTSC, or another) to produce a signal of read request 43. This signal refers to those specific places of the SDH frames to. which bytes of the video information stored in the buffer memory are to be mapped according to the selected periodic mapping pattern;

Address counter block 44 synchronized by the transport clock Tc, which produces each new read address 45 for reading data from the buffer memory upon receiving a new read request 43; moreover, upon receiving a signal 39 of a new video frame, block 44 performs reset and starts counting the read addresses from the beginning of the buffer memory;

Actually, the Read Address Generator 30 acts not only as a synchronizer, but also as a mapper, since when a Tc clock signal is not accompanied by the read request, a stuffing byte is mapped into the SDH frame, and when a Tc clock is “enabled” by the read request, a video byte is read from the buffer memory to the SDH frame.

FIG. 3a schematically illustrates a standard frame of an STM-4c data stream of the SDH transmitting technology. STM-4c data stream is composed by byte-interleaving multiplexing of four STM-1 data streams into one synchronous payload envelope. To illustrate this fact, a standard STM-1 frame is shown with four-fold numbers of bytes forming various sections of the STM-4c frame. Such a four-fold frame is transmitted each 125 microseconds, like the basic STM-1 frame.

The standard basic SDH frame STM-1 (or the SONET frame STS-3) repeats itself each 125 microseconds and looks as follows: it has 270 columns and 9 rows of bytes divided into a payload portion and an overhead portion. The overhead portion comprises the following areas: section overhead SOH, AU (administrative unit) pointers, and path overhead POH. The shadowed area to the right of the POH in the frame is its informational payload, which can be filled with the digitized video information from the buffer memory. Bytes of the payload (the shadowed area) can be occupied by any digital information, including the video information.

FIG. 3b. One 270 Mbps video signal occupies two STM-1 data streams being components of one STM-4 data stream. The drawing refers to this case, and the illustrated frames are therefore marked by two-fold numbers of bytes in the columns. For the synchronized transmission of one 270 Mbps PAL video signal via SDH, the Inventors proposed two types (type A and type B) of mapping the STM-1 standard frames. The shadowed portions schematically illustrate bytes of the payload, occupied by the digitized video information (so-called main portion of the payload). The section VH is a Video Header byte containing information on the video standard, and information on the mapping pattern for a decoder placed at the receiving side. The remaining portion of the payload is a stuffing portion.

According to the invention, the best mode of the method is achieved when loading the binary video information of V complete video frames into payloads of S complete SDH frames by an integer number B of video bytes, whenever at least one of the three numbers is minimal.

To implement this, the information may be spread between the stuffing and the main portions of the payload in a pre-selected manner, and this manner may periodically repeat in a succession of frames.

Let's demonstrate a particular example of calculating the mapping/stuffing pattern for an SDI video stream with the bit rate of 270 Mbps.

First of all, if the video information will be mapped by bytes, lets define a so-called video bytes rate VBR:

VBR=270,000,000:8=33,750,000 bytes/s

Let's see, how the bytes would be mapped in the payload of SDH data frames having the frequency 8 KHz (i.e., changing once each 125 microseconds):

33,750,000:8,000=4218.75 bytes

The obtained number is the average number of video bytes in the payload of one SDH standard frame. It can be seen that this number is not integer.

Knowing that SDI with the bit rate 270 Mbps can be carried by two STM-1s, we can obtain the average number of video bytes in one STM-1 data stream:

4218.75 bytes :2=2109.375 bytes

FIG. 3b illustrates the mapping pattern for the European PAL video transmission system which is calculated as follows:

1.The PAL video frame comprises 625 rows each comprising 1728 10-bit pixels, so that one PAL video frame comprises:

(625*1728*10):8=1,350,000 bytes

2. The number of SDH frames in one PAL video frame is:

1,350,000:4,218.75=320, which appears to be integer.

3. The minimal number of SDH frames to transmit integer number of video bytes by STM-1 can be found and will be 8:

2109.375*8=16875,

4. Since 320 can be evenly divided by 8, the pattern period for mapping one integer video frame may periodically repeat not only each 320 frames, but even each 8 SDH frames;

5. Remembering that the period is 8 SDH frames, and the average number of video bytes in one SDH frame is 4,218.75, we obtain the video period in bytes:

4,218.75*8=33,750 bytes;

6. The mapping can be selected as follows, i.e. the SDH 8-frame structure period may contain:

seven SDH frames of the mapping type A, where the video bytes are mapped in the payload as follows:

{[(234*2*8 rows)+(237*2)]*7} bytes, and

one SDH frame of the mapping type B:

[(234*2*8rows)+(240*2)] bytes,

The selected mapping pattern can be seen in the shadowed (main) portion of the frames marked “type A” and “Type B” in the drawing.

In total, 33,750 bytes will be mapped in 8 SDH frames forming a Pattern Cycle for one PAL video frame.

[Explanation to the calculation: The SDH frame has 9 rows. In 8 of them, the payload is mapped by short 234 byte-long sections in each of two STM-1s (remember that four STM-1 can be loaded in one frame of STM-4). In the ninth row of STM-1 there is a long 237 byte-long mapping in 2 STM-1s say, for the first 7 frames, and a long 240-byte mapping in 2 STM-1s for the last 1 SDH frame.]

FIG. 3c illustrates one proposed example of the pre-selected periodical mapping of video bytes of one NTSC 270 Mbps signal onto two STM-1 data streams. As can be seen, it is performed using three types of mapped frames : Type A, Type C and Type D. The mapping is calculated as follows:

1. In one video frame of NTSC, there are 525 lines each having 1,716 pixels of 10 bits each, so in bytes there are:

525*1,716*10:8=1,126,125 bytes.

2. Since the same transport clock is used, the average number of video bytes per one SDH frame is the same as that in PAL and equal to 4,218.75 bytes/frame;

3. Let's find the number of SDH frames required for transmitting one NTSC video frame:

1,126,125:4218.75=266.933(3)

4. Then, the minimal integer number of video frames can be found, which can be transmitted by integer number of SDH frames, and it is 15:

266.933(3)*15=4004

5. Number of video bytes in the above 4004 frames of STM-1 will be:

4004*2109.375=8445937.5

6.Thus, period of the pattern will be 4004*2=8008 SDH frames which will carry an integer number of video bytes (8445937.5*2) of the integer number 30 of the video frames. (2 is due to 2 STM-1 streams of the STM-4)

7. The mapping pattern in the SDH frames can be selected as follows: For the first 29 video frames, 266 SDH frames shall use type A of the mapping, and one frame-type C of the mapping, i.e.:

[(234*2*8+237*2)*266+(246*2*8+240*2)]* 29;

For the last 30-th video frame, 234 SDH frames shall use type A of the mapping, and one frame—type D of the mapping, i.e.:

(234*2*8+237*2)264+(249*2*9).

The total number of bytes in the above mapping pattern is equal to 33,783,750 (can be obtained also as 4,218.75*8,008 SDH frames). This integer number of bytes can be mapped into 8008 SDH frames, thus forming the STNC pre-selected pattern cycle for 30 video frames.

[Explanation: the numbers 266+1 and 264+1 of the SDH frames were selected to use integer numbers instead of the non-integer number 266.933(3) reflecting the average number of SDH frames needed for transmitting one NTSC video frame].

As can be concluded from the above two examples, the period of the mapping pattern always comprises an integer number B of video bytes and an integer number S of SDH frames. Preferably, the integer number V of video frames may be equal to the mapping pattern period or be evenly divisible by the period of mapping pattern. However, the integer number V can be also a multiple of the mapping pattern period.

It is understood that, for an SDI video signal having a different bit rate, the mapping pattern can be selected in the analogous manner. For example, the 360 Mbps SDI video signal occupies three STM-1 components of the STM-4 data stream, so the calculations should be modified accordingly.

While the invention has been described with respect to a limited number of embodiments, it should be appreciated that other variations, modifications, and applications of the invention stemming from different video standards, bit rates, different data streams of a synchronous transmission technology, different structure of the memory or the read address generator, etc. might be proposed within. the scope of the following claims, and are to be considered as part of the invention.

1. A method of synchronizing a digital video signal for transmitting it in the uncompressed form via a synchronous hierarchy network having its internal clock, by standard frames of said network, the method comprising steps of:
obtaining the video signal as a Serial Digital Interface (SDI) signal having its initial video clock and representing succession of video frames,
storing said video signal, using the video clock, in a buffer memory having capacity of one or more complete video frames,
reading said video signal from the buffer memory using a transport clock derived from the internal clock of said network.

2. The method according to claim 1, wherein said synchronous transmission technology is SONET or SDH.

3. The method according to claim 1, wherein the buffer memory capacity is a single complete video frame.

4. The method according to claim 1, wherein said reading is performed by bytes.

5. The method according to claim 1, comprising obtaining the transport clock based on the bit rate of a data stream of said network, suitable for transmitting said SDI video signal having a particular bit rate.

6. The method according to claim 1, further comprising mapping the digital video signal into said standard frames using a pre-selected periodically repeating pattern known at both the transmitting and the receiving side.

7. The method according to claim 6, wherein the mapping comprises introducing in each particular standard frame a video header byte having a specified position and bearing a mapping pattern data for this particular standard frame.

8. The method according to claim 6, wherein the mapping using the pre-selected periodically repeating pattern comprises a pre-selected order of inserting a particular integer number B of video bytes into payloads of an integer number S of the synchronous hierarchy standard frames, where B video bytes represent information comprised in an integer number V of the video frames.

9. The method according to claim 8, comprising arbitrary selecting a mapping pattern type for each particular frame among said S frames, the mapping pattern type being a number and location of video bytes and stuffing bytes in said particular frame, and repeating the arbitrary selected mapping pattern types each cycle comprising N of the standard frames, being equal to k*S frames, where k is either a positive integer number or a value inverse to a positive integer number.

10. The method according to claim 9, wherein said pre-selected periodical mapping pattern is formed in N said standard successive frames by a limited number of the mapping pattern types, each frame from said N standard successive frames being assigned to a particular mapping pattern type.

11. The method according to claim 1, further comprising steps of:
obtaining at least one additional video signal in the digital form, each having its video clock,
storing each of said additional video signals, using its corresponding. video clock, in a buffer memory having a capacity of one or more complete video frames and associated with this particular additional video signal;
reading each of said additional video signals from its associated buffer memory, using said transport clock derived from the internal clock of said network,
thereby synchronizing different video signals initially having their corresponding video clocks by one and the same transport clock.

12. The method of claim 11, further comprising mapping of each of said additional video signals using its corresponding predetermined periodic mapping pattern.

13. The method according to Claim 1, for synchronizing and mapping two SDI digital video signals having the bit rate of 270 Mbps into one STM-4 data stream having the bit rate of 622.08 Mbps.

14. A system for synchronizing an SDI (Serial Digital Interface) video signal having its video clock for transmitting thereof via a synchronous technology network having its internal clock, by standard frames of said network; the system comprising:
a buffer memory capable of storing in it video information comprised in one or more complete frames of the SDI video signal,
a write address generator for storing the video information in the buffer memory using said video clock,
a read address generator for reading the video information from the buffer memory using a transport clock derived from the internal clock of the synchronous technology network.

15. The system according to claim 14, wherein said synchronous transmission technology is either SONET or SDH.

16. The system according to claim 14, wherein the buffer memory has the capacity of a single video frame.

17. The system according to claim 14, wherein the read address generator is designed for reading the video information by bytes from the buffer memory.

18. The system according to Clam 1, wherein said read address generator is capable of mapping the video information into said standard frames of the network by using a pre-selected periodic mapping pattern information preliminarily introduced in said read address generator.

19. The system according to claim 18, wherein the read address generator is designed for indicating a mapping pattern data used in each specific standard frame by means of a predetermined byte of said standard frame.

20. The system according to claim 18, wherein the address generator comprises a counter of frames of said SDI video signal, a counter of the synchronous technology frames and bytes therein, a control unit capable of processing data obtained from said two frame counters and data on the pre-selected periodic mapping pattern to issue read request signals, said generator further comprises a read address counter synchronized by the transport clock and capable of processing said read request signals for producing a read address to be used for the reading from the buffer memory according to said pre-selected periodic mapping pattern.

21. The system according to claim 14, comprising a plurality of buffer memories, each associated with its write address generator and its read address generator, and each being adapted for buffering a particular SDI video signal belonging to a corresponding video channel.

22. The system according to claim 21, designed for a respective plurality of SDI video signals having their particular bit rates, the system being capable of synchronizing and mapping said video signals into respective SDH/SONET data streams, and is further provided with a multiplexer for multiplexing the plurality of said data streams into one or more higher order SDH/SONET data streams.
